(19) United States
(12) Patent Application Publication
(10) Pub. No.: US 2004/0205178 A1
(43) Pub. Date: Oct. 14, 2004

(54) Communication system and method between stations processing common folders

(76) Inventor: Alain Gruson, Verrieres Le Bruisson (FR)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(21) Appl. No.: 10/476,127

(22) PCT Filed: Mar. 11, 2002
(86) PCT No.: PCT/FR02/00863

(30) Foreign Application Priority Data
Apr. 27, 2001 (FR) 01/05718

(51) Int. Cl. G06F 15/173

(52) U.S. Cl. 709/223; 709/238

(57) ABSTRACT

The invention concerns an electronic communication system between stations (A, B, C, D, comprising means for being mutually connected via at least an Internet-type network (SR1, SR2, SR3) characterised in that the stations (A, B, C, D, E) form part of at least a common work group for at least one application, each station comprising for each application a common object database, the object databases being automatically updated via the network (SR1, SR2, SR3).

In general, the invention relates to electronic communication systems that enable stations remote from each other to communicate with each other, and more particularly an electronic communication system that connects stations together that can process common folders, and a method for implementation of such a system.

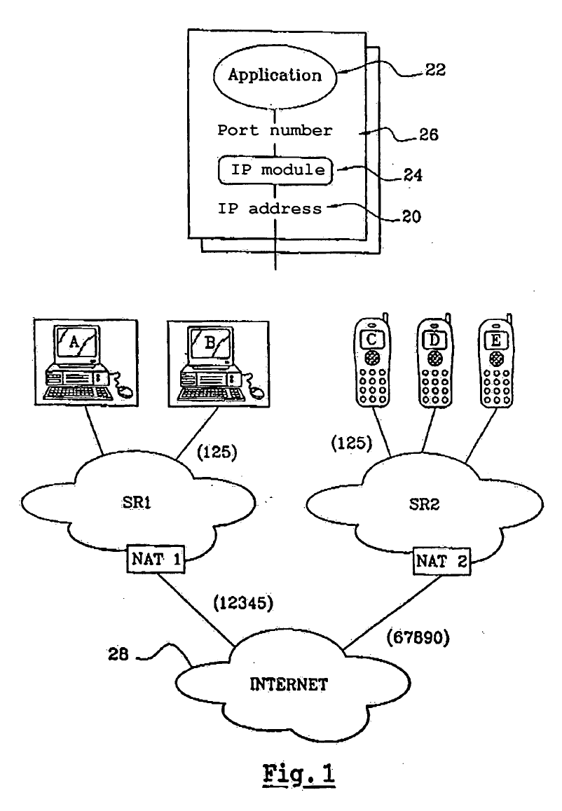

FIG. 1 shows an existing electronic communication system between stations. For example, it includes five stations A, B, C, D and E, where A and B are office computers and C, D and E are so-called intelligent mobile phones or palmtop computers. Computers A and B communicate with each other through a LAN or sub-network SR1 while mobile phones also communicate with each other through a sub-network SR2.

Computers A and B use a communication protocol called the IP protocol for this purpose, where IP stands for Internet Protocol, and this protocol uses the fact that every computer connected to the LAN has an address characteristic of the computer, called the IP address 20. Thus, when the IP protocol is used, an application 22 running on computer A can ask communication programs contained in an IP module 24 to set up a connection with another application operating on the other computer B.

To achieve this, it supplies the IP address 20 of the computer B with which it wants to communicate, together with an application number 26 called the “Port number”. If computer B activated the application capable of receiving the traffic corresponding to the given port number, then its own IP module will inform the application about the connection request. If application accepts the connection, the application on computer B can then dialogue with the application running on computer A.

Mobile phones and palmtop computers C, D and E comprising a microprocessor and a sufficiently large memory to enable the execution of applications such as organisers and directories, are connected by radio to the sub-network SR2 operated by an operator. Like computers A and B, they contain IP modules that are used to set up links between the applications.

The various sub-networks SR1 and SR2 are connected to the INTERNET network 28 through commercially available devices called NATs, where NAT stands for “Network Address Translator” referenced NAT1 for sub-network SR1 and NAT2 for sub-network SR2. With this arrangement, information packets transported according to the IP protocol can be exchanged between two stations, even if they are not connected to the same sub-network since the packets can transit through the INTERNET network 28.

However, it is possible that two stations A and C belonging to two different sub-networks have the same IP address (125), each in their own sub-network. In order to solve this ambiguity, the INTERNET network administrators will assign a batch of IP addresses to each NAT device, so that each NAT device can be unambiguously identified on the INTERNET network.

In the case of a link between two stations, the NAT device temporarily associates the IP address of the station in the sub-network with an IP address chosen in its own batch of INTERNET addresses, thus making the sub-network station visible from the INTERNET network. This association is called an address translation.

Thus, station A belonging to sub-network SR1 and corresponding to the IP address (125) can dialogue with a station C belonging to the sub-network SR2, even if it has the same IP address (125) since the device NAT1 in sub-network SR1 will transform the address (125) of A into a unique address (1-2-3-4-5) while the device NAT2 on sub-network SR2 will transform the address (125) of C into another unique address (67890). Station A will then dialogue with station C at address (6-7-8-9-0) while station C will then dialogue with station A at address (1-2-3-4-5).

The description in FIG. 1 shows that it is possible to make stations A, B, C, D and E communicate with each other, although they are connected to different sub-networks but these communications are only set up temporarily. The result is that this type of operation is not suitable for setting up semi-permanent communications between stations A, B, C, D and E if these stations share common folders for which several exchanges are necessary to update them.

Therefore one purpose of this invention is to make a system and implement a method to enable different stations to communicate with each other easily, particularly in order to update common folders.

The invention also relates to a method of updating files that are common with different stations as they are created or modified by station users.

According to prior art, links can be set up between stations A, B, C, D and E, but these links assume mutual knowledge of the station addresses, which is not always the case. Furthermore, communications between users are usually limited to:

the use of question/answer type dialogues with servers,

the use of message service software to enable asynchronous transfer of messages from one station to another through a server network.

Therefore, information exchanges take place but, for a specific application, there is no group of stations that share common folders that are updated at all times in each station in the group.

The invention satisfies this need by:

providing an objects database for each application in each station in a work group,

providing practically permanent direct links between stations in the same work group to update databases.

Therefore, the invention relates to an electronic communication system between stations comprising means of connecting to each other through at least one INTERNET type network, characterised in that:

the said stations form part of at least one work group for at least one application, each station comprising a same objects database for each application, the object databases being automatically updated through the network.

The system is also characterised by:

a central server connected to the network to manage the said stations in at least one work group and to determine authentication certificates for each notation,

at least one referencing server connected to the network to set up direct links between stations in the same work group.

Each station comprises:

memory means to save the objects database corresponding to the said application, and programs necessary for implementation of the application, and

a microprocessor and its associated memories to carry out operations defined by the said programs.

The programs comprise:

a first group of programs to set up an authenticated link between two stations with the same application, and

a second group of programs to create and modify the database.

The first program group comprises:

a first program to connect to the central server when the application is installed in order to determine an authentication certificate for the station concerned,

a second program to periodically connect to the referencing server in order to register station localisation elements in it,

a third program to set up a link between the said station and another station in the same work group, and

a fourth program to mutually authenticate the calling and the called stations using the authentication certificate produced by the first program.

The second program group comprises:

a fifth program to create or modify at least one object in the objects database, and

a sixth program to transmit any modification made in the objects database on one station to all the other stations in the same work group so as to modify the object databases on the other stations.

The third program to set up a link between the said station and another station in the same work group makes connection attempts consisting of:

(T1) searching for a link with the last known address of the called station, and if this fails,

(T2) searching for the called station in the sub-network to which the calling station is connected, and if this fails,

(T3) interrogating the referencing server to know the localisation elements of the called station, and if this fails,

(T4) waiting until the called station sets up a link with the calling station.

Other characteristics and advantages of this invention will become clear after reading the following description of a particular example embodiment, the said description being made in relation to the attached drawings in which:

FIG. 1 already described in the preamble to this document, is a diagram showing an electronic communication system between stations according to prior art,

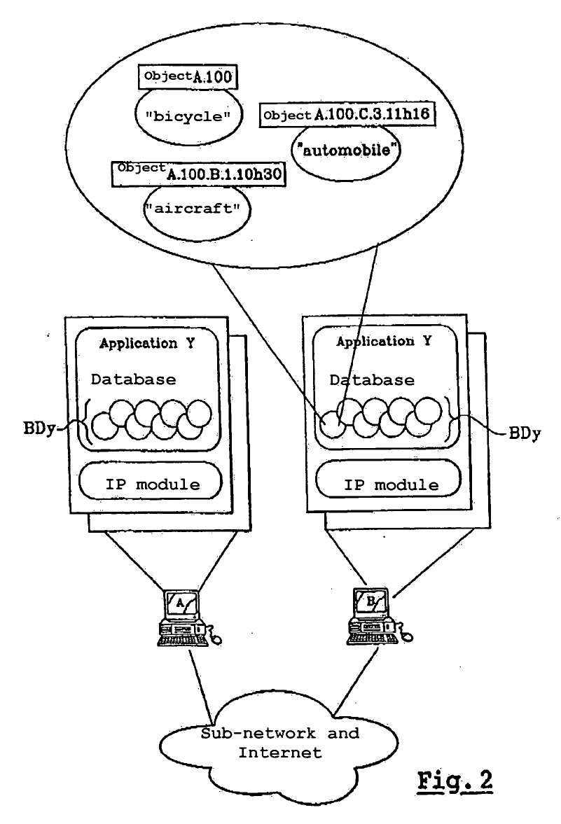

FIG. 2 is a diagram illustrating updating of databases of stations in a group processing common folders according to the invention,

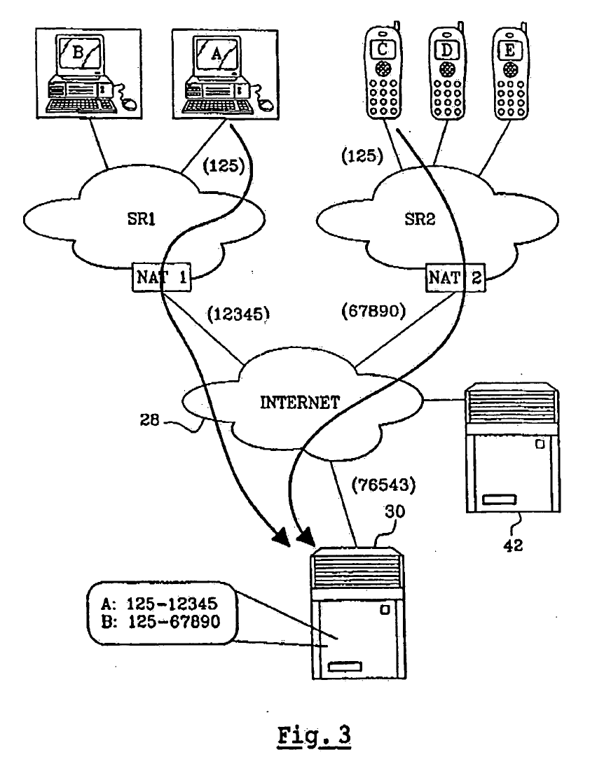

FIG. 3 is a diagram of an electronic communication system between stations according to the characteristics of this invention,

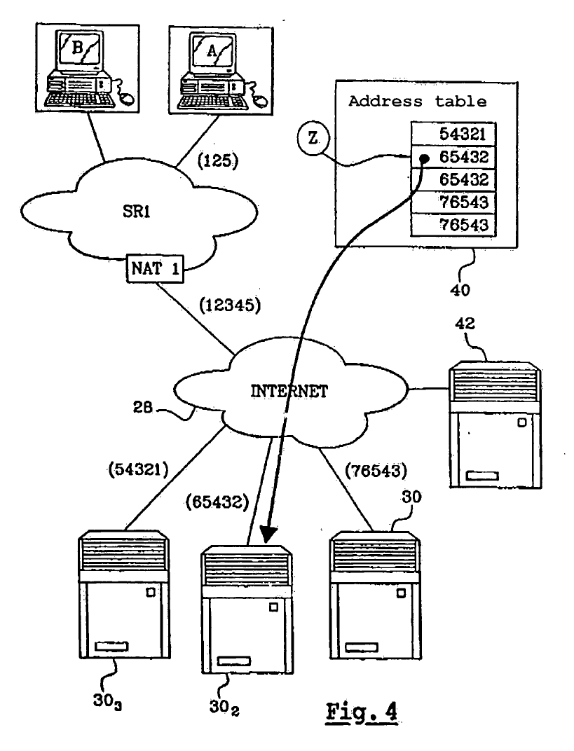

FIG. 4 is a diagram of an electronic communication system using several referencing servers according to the invention,

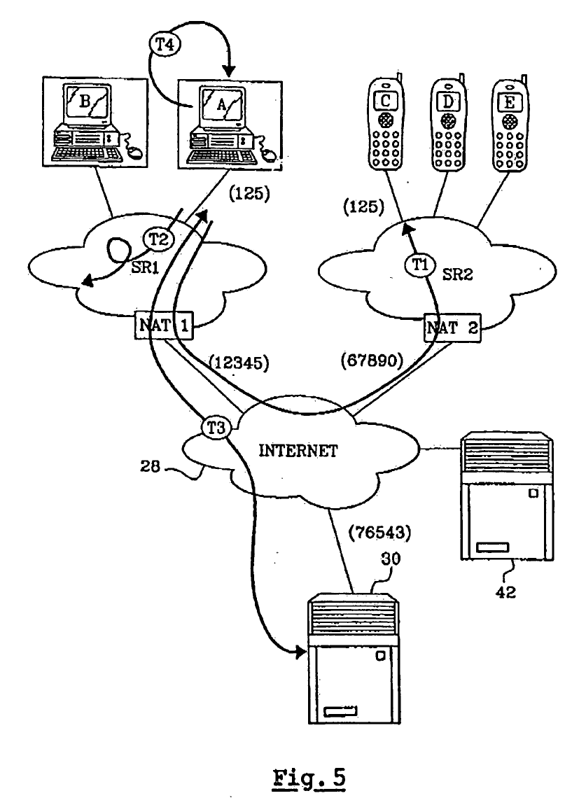

FIG. 5 is a diagram illustrating how links are set up in the electronic communication system between stations according to the invention,

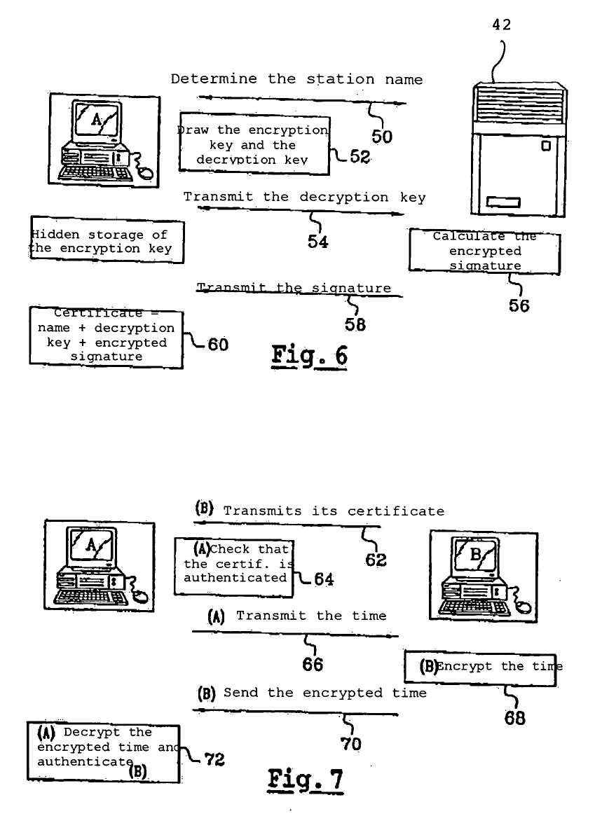

FIG. 6 is a diagram illustrating how a certificate is determined for a station,

FIG. 7 is a diagram illustrating authentication of station B by station A.

FIG. 2 is a diagram showing organisation of two stations A and B that form part of the same work group for a given application Y.

All stations belonging to the same work group have a copy of the same objects database, BDy for application Y, which is characteristic of the work group, on their hard disk or in their memories.

Each object in the database BDy has a single reference composed of the name of the station that initially created it associated with a number; software means ensure that the same reference cannot be assigned to two different objects.

These objects contain data characteristic of a dialogue between colleagues in the same work group working together on common folders; they may be unformatted messages, formatted records according to a predefined model or references of documents or office automation files.

Depending on its type, the information contained in the objects may be displayed on the station screen and/or modified by means of the station keyboard or any other device.

The database BDy also contains a list of stations belonging to other members of the work group, and the last IP address with which a connection was set up with the station will be associated with each station name A, B, C, D and E.

As soon as an object is modified, the current application on the station on which the modification was made will automatically set up IP links with all other stations belonging to the same work group.

When a connection is made with a station belonging to the same work group, the current application on station A in which the modification took place sends a message formatted in an agreed manner and containing information necessary for the other application on the other station B to update all or some of the information contained in the object in its own database and corresponding to the reference of the modified object, to the current application on the other station B.

If there is no such object in station B, it will be created.

This method is implemented between station A and all other stations in the same work group such that all databases BDy on stations in the same work group will contain the same objects, each identified by the same reference and containing the same information.

Some rules have to be defined, because the modifications in the same object may originate from different stations at different times.

If station B modifies an object A.100 created by station A, replacing the word “bicycle” contained in it by the word “aircraft”, and if station C modifies the same object A.100, replacing “bicycle” by “automobile”, it will be impossible to determine if the object A.100 should contain “aircraft” or “automobile”.

This problem is solved by programming the application running on a station such that it is only authorised to modify the contents of an object if it is the creator of this object, in other words if the reference of the object concerned contains its name.

If the station that wants to modify the object is not the creator, then it creates a derived object in the same form as the initial object, but with its reference being the reference of the initial object followed by the name of the modifying station, a unique number and the creation time as read in the local time of the modifying station. Thus, this modifying station places the information that it would like to be modified in the initial object, into the created object.

The derived objects are identified by references:

object A.100-B-1-10h30 for the “aircraft” modification made by station B (the first modification B-1), and

object A.100-C-3-11h16 for the “automobile” modification by station C (the third modification C-3).

The derived objects are then transmitted to all other stations in the same work group using the method described above.

When the station A that created the object will receive a copy of the derived object(s) created by the other stations B and C in the same work group, its application Y will be able to decide whether or not to integrate all or some of the contents of the derived objects in the initial object. This decision may be taken using appropriate algorithms that depend on the functional use made of the object.

If it is found that this decision cannot be made, a warning message will be displayed on the screen of the creating station A, and the user will be responsible for solving the conflict.

If the decision making algorithms need to know the order in which the derived objects were created, for example so as to only keep the most recent derived object, then a procedure to exchange local station times when each link is set up will be used. Thus, when station A is connected to a station B, it transmits the time to it as read on its local clock so that station B will know the time difference between station A's time and its own time, and can then translate any time stamping made by station A into its local time.

As soon as derived objects have been integrated, connections will be set up with other stations in the same work group to transmit the initial object as modified to all other stations and derived object cancellation messages, including in the creating station.

The information contained in the objects may be modified by any member of the same work group, using methods and means described above in relation to FIG. 2, without prior locking of information like that done in distributed database systems.

The above description in relation to FIG. 2 shows that it is necessary to organise direct link between stations in the same work group to make these updates to database objects on stations.

As indicated in the above preamble, the address translation made by NAT1 arid NAT2 devices in their function to connect a sub-network SR1 or SR2 to the INTERNET network 28 makes it difficult to set up a semi-permanent connection between a station A belonging to sub-network SR1 and a station C belonging to sub-network SR2.

The invention solves this problem by using a referencing server 30 (FIG. 3), in the diagram in FIG. 3, this diagram being identical to that shown in FIG. 1 corresponding to prior art except for the addition of this server 30 and a central server 42 to be used for determination of a station authentication certificate.

The referencing server 30 is connected to the INTERNET network 28 at a fixed IP address perfectly known to all stations, this address depending on the name of the station with which a station wants to set up a link.

In order to set up an IP link, station A periodically sends a message to the referencing server 30 using the IP address of this server known to all stations, for example (76543). This message contains the name of the station A and the IP address (125) that it has in the sub-network SR1. The referencing server that receives this message will find this information in it (the name of station A and the IP address (125)), and the IP address of station A as translated by the device NAT1 in sub-network SR1, namely (1-2-3-4-5). This information is written in memory in the referencing server for each station A, B, C, D and E. Thus, for station C, this memory will contain the IP address (125) of station C in sub-network SR2 and the IP address (6-7-8-9-0) as translated by the device NAT2 in sub-network SR2.

Consequently, station A can know the IP address of station C by previously setting up a link with the referencing server to request the last known IP address for station C using an appropriate program, namely (6-7-8-9-0).

In some cases, commercially available NAT devices make checks intended to prevent unauthorised data flows; these devices are then called “firewalls”. The invention proposes to use the port number “80” to pass through firewalls in the direction from the sub-network to the INTERNET network, since this port number is specific in that it can be used by any servers in the INTERNET network and is usually not filtered.

In order to pass through firewalls in the INTERNET to sub-network direction, the station will periodically send messages to port 80 on the referencing server or to any other referencing server for which it knows the IP address, as described below. The firewall will trigger an internal mechanism by which it authorises the interrogated referencing server to reply to the sending station for a time fixed by the administration of the NAT device. Thus, if the time between two periodic messages sent by the station to the INTERNET network is less than the time fixed by the NAT administrator, then the address translation made by the NAT device will remain the same over time and the NAT device will allow traffic from the INTERNET network to pass towards the sending station.

If a large number of stations communicate with each other, messages traffic sent to the referencing server could saturate the referencing server.

In order to solve this saturation problem, the invention proposes to put several referencing servers 30, 302, 303 (FIG. 4) into service, so that each carries part of the traffic.

In this way, each station will contain an address table 40 comprising n items in its memories, the items usually containing IP addresses of the p referencing servers in service. If p<n, then several stations contain the same address as shown in FIG. 4.

The following method is used when a station wants to address the referencing server responsible for memorising data for a station Z:

calculation on the name of station Z to give a result r between 1 and n,

read the IP address of the referencing server managing station Z, for example referencing server 30₂, in the r^{th} item of the address table 40,

the sending station then sends a message to this referencing server 30₂, this message being constructed to contain the name of Z; if this referencing server 30₂ really knows how to manage the station Z, then the application continues.

Otherwise, the address table 40 of the sending station is not up to date and the referencing server 30₂ downloads an up to date table using an appropriate protocol to the sending station, and the method described above is then restarted with this up to date table.

The invention proposes to make attempts to set up a link between two stations in a determined order starting from the station that consumes the least resources and ending with the station that will consume the most, to prevent an IP address of a NAT device being monopolised by one station.

The first attempt T1 (FIG. 5) consists of requesting the IP module on station A to set up a link with the last known address of station B recorded in the address table 40 (FIG. 4) of station A.

If this first attempt is not successful, then the second attempt T2 is made that consists of asking the IP module of station A to activate the search function for a correspondent in the sub-network in which station A is located.

If this second attempt is not successful, the third attempt T3 is made that consists of asking the referencing server 30, 30₂ or 30₃ that recorded the last known address for station B, to send this address to station A, and this station A will use this address to attempt to set up a link.

If this attempt is not successful, then the fourth attempt T4 is used that consists of station A waiting for station B to set up a link with station A on its own initiative. After the link has been set up, station A will send the information in waiting to station B.

Note that in the procedure for these different attempts T1 to T4, setting up a link with a station is not a sufficient criterion for success of the attempt since if a station responds, station A will attempt to authenticate the application that responded, to check if it is authorised to run on station B according to the authentication procedure that will be described below with reference to FIGS. 6 and 7.

This authentication process will be carried out in two phases:

the first phase to determine a certificate for each station (FIG. 6),

the second phase to authenticate one station by another station using the certificate obtained during the first phase (FIG. 7).

The first phase is carried out when the application according to the invention is installed on a station. It consists of setting up an automatic link with the central server 42. This central server will ask the user of the station, for example by a display on the station screen, to input the required name for the station. The central server examines its memories to check that this name is not already used by another station. Once the name has been accepted 50, the station will determine the encryption and decryption keys (52), for example from the date and time read on its central clock, that will be used to encrypt and decrypt the information with an algorithm. This algorithm uses a secrete encryption key that is stored unknown to anyone in one of the memories in the station, and a public decryption key that is transmitted (54) to the central server. The central server sets up (56) a characteristic signature of the input data, using an algorithm using the name of the station and the public decryption key as input data. This signature is encrypted (56) by the same algorithm using a secret key known to the central server operator. This encrypted signature is transmitted to the station (58).

For the authentication phase, the station certificate will comprise the set (60) consisting of the station name, the public decryption key of the station and the encrypted signature.

The second phase is implemented when a link between a station A and a station B is set up.

Station B sends (60) its certificate at the request of station A. Station A calculates the signature of station B by applying the central server algorithm to the name of the station B and its public decryption key.

Station A then uses the public decryption key corresponding to the secret key known to the server operator, to check (64) that the calculated signature actually corresponds to the decrypted signature.

In this way, station A checks that the certificate sent by station B is actually a certificate delivered by the central server 42.

Station A transmits (66) the local time to station B. Station B encrypts (68) this local time using its secret key and transmits (70) the encrypted time to station A.

Station A decrypts (72) the encrypted time using the public key of station B. If the decryption result corresponds to the time transmitted by station A to station B, station A will deduce that the station with which it is connected is actually station B.

The same method is applied to authenticate station A by station B.

1. Electronic communication system between stations (A, B, C, D, E) comprising maeans of connecting to each other through at least one INTERNET type network (SR1, SR2, 28), characterised in that:
the stations (A, B, C, D, E) form part of at least one work group for at least one application Y, each station comprising a same objects database (BDy) for each application, the object databases (BDy) being automatically updated through the network (SR1, SR2, 28).

2. System according to claim 1, characterised in that the network comprises:
a central server (42) connected to the network (SR1, SR2, 28) to manage the stations (A, B, C, D, E) in at least one work group and to determine authentication certificates for each station, and
at least one referencing server (30, 30₂, 30₃) connected to the network (SR1, SR2, 28) to set up direct links between stations (A, B, C, D, E) in the same work group.

3. System according to claim 1 or 2, characterised in that each station (A, B, C, D, E) comprises:
memory means to save the objects database (BDy) corresponding to the said application, and programs necessary for implementation of the application, and
a microprocessor and its associated memories to carry out operations defined by the said programs.

4. System according to claim 3, characterised in that the said programs comprise at least:
a first group of programs to set up an authenticated link, and
a second group of programs to create and modify the database BDy.

5. System according to claim 4, characterised in that the first group of programs comprises:
a first program to connect to the central server (42) when the application is installed in a station in order to determine an authentication certificate for the station concerned,
a second program to periodically connect the station to the referencing server in order to register localisation elements of the said station,
a third program to set up a link between the said station and another station in the same work group, and
a fourth program to mutually authenticate the calling and the called stations using the authentication certificate produced by the first program.

6. System according to claim 5, characterised in that the third program makes connection attempts consisting of:
(T1) searching for a link with the last known address of the called station, and if this fails,
(T2) searching for the called station in the sub-network to which the calling station is connected, and if this fails,
(T3) interrogating the referencing server (30) to know the localisation elements of the called station, and if this fails,
(T4) waiting until the called station sets up a link with the calling station.

7. System according to claims 4, 5 or 6, characterised in that the second group of programs comprises:
a fifth program to create or modify at least one object in the objects database (BDy), and
a sixth program to transmit from one station to all the other stations in the same work group any creation or modification made in the objects database (BDy) of the said station on one station to all the other stations in the same work group so as to modify the object databases on the other stations.

8. System according to claim 7, characterised in that the fifth program consists of enabling each station to:
create at least one initial object and to identify (A.100) this initial object,
modify this initial object (A.100),
create a derived object (A.100, B.1) modifying an initial object (A.100) created by another station,
accept or not accept the modification of the initial object by the derived object (A.100, B.1, 10h30) if the station created the initial object (A.100).

9. System according to one of claims 2 to 8, characterised in that the referencing server (30, 30₂, 30₃) comprises at least one memory in which the localisation elements of stations (A, B, C, D, E) of the same work group in the network are registered.

10. System according to claim 9, characterised in that the said memory registering the said localisation elements of the stations is updated periodically by stations in the same work group.
